(19) United States
(12) Patent Application Publication
(10) Pub. No.: US 2007/0228237 A1
(43) Pub. Date: Oct. 4, 2007

(54) Paint tray/paint can shelf support for hollow rung ladders

(76) Inventor: Gerald M. Pochurek, Ocean, NJ (US)

Correspondence Address: ROBERT M. SKOLNIK, 353 Monmouth Road, PO Box 22, West Long Branch, NJ, 07764-0022, US

(21) Appl. No.: 11/395,382

(22) Filed: Mar. 31, 2006

(51) Int. Cl. E06C 7/14

(52) U.S. Cl. 248/210

(57) ABSTRACT

A paint tray/can shelf support for hollow rung ladders provides enhanced support for the tray to ensure that the shelf does not tip against the rotational moment of force generated when a paint tray is placed on the shelf support or when a paint is not placed precisely centrally on the shelf support by supporting the shelf on the rail of the ladder with one or more notches having at least one angled wall formed therein. Inserts are provided to accommodate ladder rails of different sizes. In another embodiment, pivoted surfaces are formed in the notches to engage the ladder rail.

### BACKGROUND OF THE INVENTION

1. Field of the Invention

The present invention relates a paint tray/can shelf support for hollow rung ladders which provides enhanced support for the tray to ensure that the shelf does not tip against the rotational moment of force generated when a paint tray is placed on the shelf support or when a paint is not placed precisely centrally on the shelf support.

2. Description of the Related Art

| D481,134 | Calaicone |
|---|---|
| 4,523,733 | Lunden |
| 4,660,794 | Given |
| 4,662,594 | Dubis |
| 5,259,525 | Wion |
| 5,934,623 | Weaver |
| 6,076,636 | Tietge |
| 6,260,663 | Combs |
| 6,352,135 | Jones |
| 6,766,990 | Hileman, et al. |
| 6,824,115 | Batson |

Calaicone is representative of a number of hollow rung supports using a rod loosely mounted in the rung and having a connector for the item to be supported. Lunden shows a holder supported in the rung on a rod. Given shows a tray supported by a rod in the rung and a clamp affixed to the opposite end of the rod for angularly adjusting and holding the tray. Dubis discloses expands a resilient rod in the hollow rung to support the tray. Wion uses a wedge to hold the rod in the hollow rung. Weaver shows a paint can support generally similar to Given in using a nut to tighten the end of the support rod opposite the pain can holder. Tietge uses the rod and a lock shown in FIG. 4 for a wire type paint can support. Combs has a ribbed and specially shaped rod. Jones has a tray and a can supported at opposite ends of the rod having fittings on the ends of the rod for mating with the can support and the tray. Hileman, et al. have a clamped extrusion to which tool supports are affixed. Batson shows a tray for a D ring hollow rung ladder with a D shaped configuration.

### SUMMARY OF THE INVENTION

The present invention is a paint can/tray shelf for use with hollow rung ladders. The invention provides secure support for the shelf so that in is preventing from rotating. The enhanced support is achieved by interfitting one or more portions of the shelf over the side rails of the ladder. The shelf as one or more notches formed therein. The side walls of the notches are either angled or pivoted to compensate for the angle of inclination of the ladder when it is set up.

The present invention eases the process of painting houses and soffets from extension ladder. A person on a ladder has limited reach with a paint brush. There is limited space to hang a paint bucket from the top rungs of a ladder. A paint can hung on a ladder with a hood interferes with the brush entering or exiting the can. Paint rollers are not used for lack of a paint tray support.

The present invention is a supported shelf having a tongue formed on one side thereof for insertion into the hollow rung of a ladder At least one notch is formed in the shelf adjacent the tongue. The notch fits onto the rails or sides of the ladder to prevent shelf rotation.

The invention may be formed from paint resistant molded thermoplastic material. Holes can be made in the shelf in areas that do not effect support strength to reduce material content.

It is recognized that extension ladders have different hollow rung shapes and different side rail widths. When the ladder is against a wall at an angle of 70°-75°, the shelf is angled at 18°. A fixed 18° angle can be molded for each rail size. Alternatively, a large sized opening may be formed and then reduced to size with inserts. Still further alternatively, pivoted angled sides and be made which are adjustable and lockable.

A principal object of the invention is the provision of a shelf used as a paint can or paint tray support which is designed for use with hollow rung ladders.

A further object and advantage of the invention is the provision of a shelf which as a tongue which is inserted into the hollow rung and at least one notch formed in the shelf adjacent the tongue for receiving a portion of the ladder's rail therein.

Another object of the invention is the provision of stabilizing structure for a shelf used with a hollow rung ladder by using the ladder's rails to prevent the shelf from rotating.

The foregoing, as well as further objects and advantages of the invention will become apparent to those skilled in the art from a review of the following detailed description of my invention, reference being made to the accompanying drawings.

### BRIEF DESCRIPTION OF THE DRAWINGS

FIG. 1 is a perspective view of the preferred embodiment of the invention:

FIG. 2 is a sectional view taken along the line 2-2 of FIG. 1;

FIG. 3 is a sectional view of a modification to the structure shown in FIG. 1;

FIG. 4 is a perspective view of a modification of FIG. 1; and

FIG. 5 is a sectional view taken along the line 5-5 of FIG. 4.

### DETAILED DESCRIPTION OF THE PREFERRED EMBODIMENT

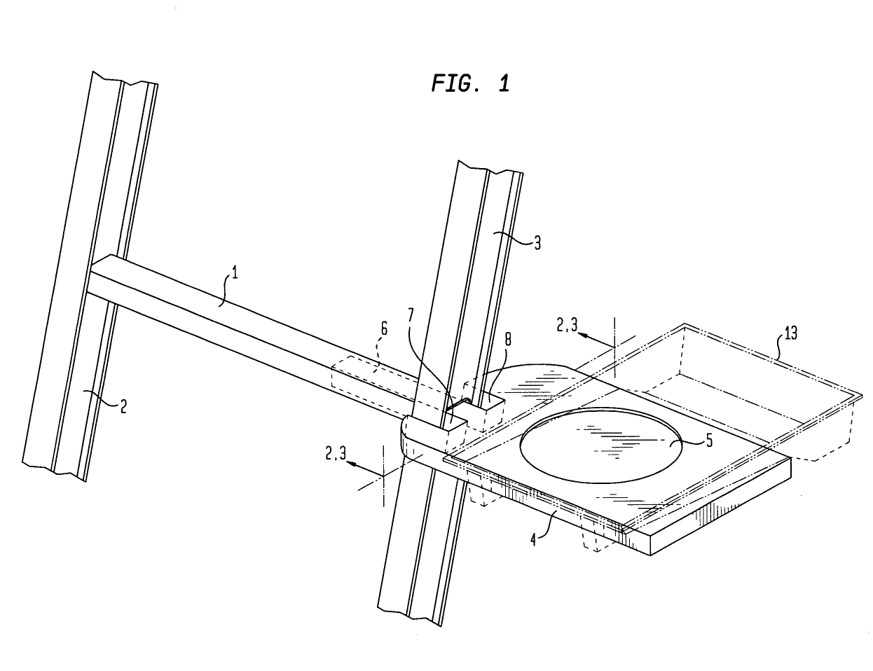

Like reference numerals have been used to designate like parts in all figures. As shown in FIG. 1, a hollow rung extension ladder having two rails 2 and 3 and a hollow rung 1. A shelf 5 has a tongue 6 connected thereto for insertion into the hollow rung 1. The tongue 6 is of such length, dimension and shape as to engage the inner walls of the hollow rung so that the shelf 5 is not free to rotate about the tongue. In order to more securely hold the shelf 5 in the horizontal pant can/tray supporting position shown, at least one, preferably two notches 7 and 8 are formed in the shelf 5 adjacent the tongue 6.

A paint tray 13 is shown in FIG. 1 attached to the shelf 5. Because of the shape of the paint tray well, a force imbalance is created on the shelf. This force imbalance exerts a rotational moment of force on the shelf. The shelf support provided by the present invention ensures stability even when a paint tray is attached to shelf.

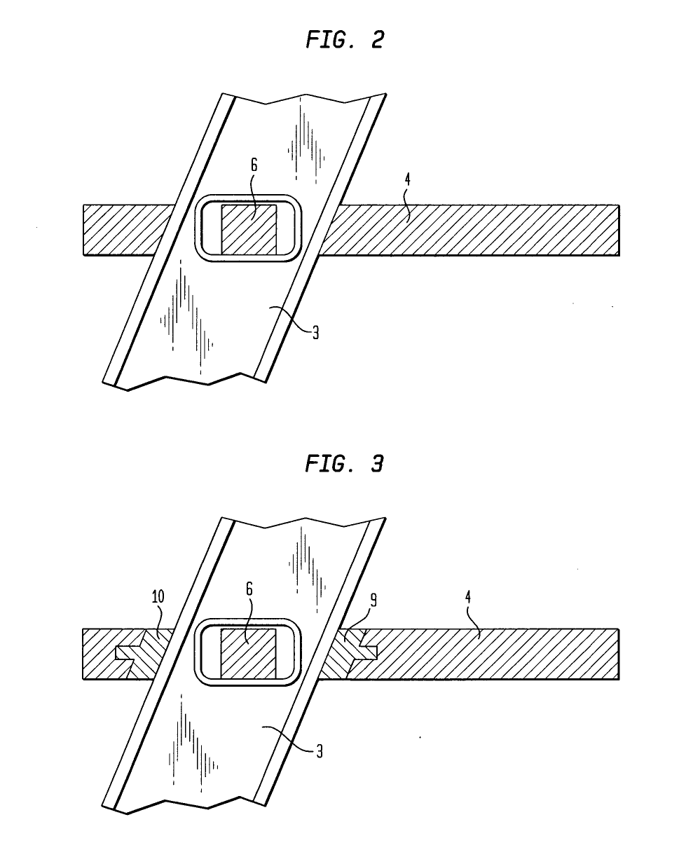

As shown in FIG. 2, a sectional view taken along the line 2-2 of FIG. 1, the side walls of the notches which contact the ladder rail 3 are formed at an angle of about 18° so that the shelf will be level when the ladder is in is position against a wall. FIG. 3 shows inserts 9 and 10 which are used to adjust the size of the notches for the width of the ladder rail 3. Inserts 9 and 10 may be affixed to the angled walls of the notches by a simple peg. Different width inserts 9 and 10 can be provided so that the dimensions of desired ladder rails can be accommodated.

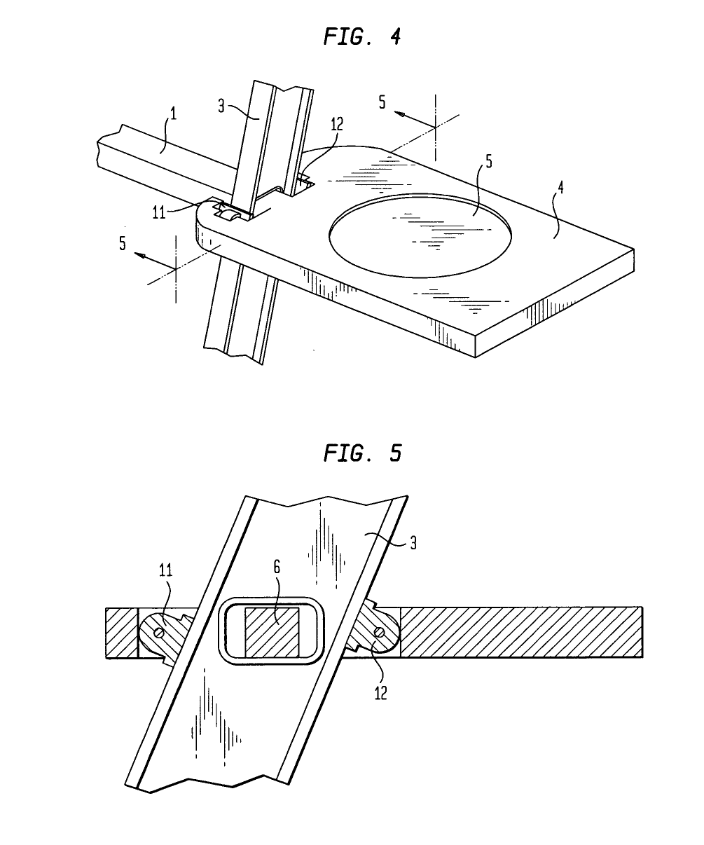

In FIG. 4 and 5, the angled walls of the notches are provided by pivotable surfaces 11 and 12 mounted in the outer walls of the notches. These pivotable surfaces permit the ladder to be used at different mounting angles on a wall while still maintaining the required horizontal position for the shelf 5

Further modifications to the invention may be made without departing from the spirit and scope of the invention; accordingly, what is sought to be protected is set forth in the appended claims.

1. A paint can/tray support shelf for hollow rung ladders comprising: a shelf; a tongue attached to said shelf; at least one notch formed in said shelf adjacent said tongue, said notch having at least one angled side wall formed therein.

2. The paint can/tray support shelf of claim 1 wherein said tongue is inserted into the hollow portion of said hollow rung and said notch fits over a ladder rail so that said support shelf is maintained in a desired position when said ladder is in use.

3. The paint can/tray support shelf of claim 1 further including at least one angled wall spacer insert connected in said notch as desired to accommodate ladder rails of different sizes.

4. The paint can/tray support shelf of claim 1 wherein said angled wall is pivotably mounted in said notch.

5. A paint can/tray support shelf for hollow rung ladders comprising: a shelf; a tongue attached to said shelf; at least one notch formed adjacent said tongue, said notch having at least one pivotable side wall formed therein for supporting said shelf on the ladder rail.

6. The paint can/tray support shelf of claim 5 wherein said tongue is shaped to tightly interfit within said hollow rung.

7. The paint can/tray support shelf of claim 5 wherein said tongue is shaped to loosely interfit within said hollow rung.

8. A paint can/tray support shelf for hollow rung ladders comprising: a shelf; a tongue attached to said shelf; notched support means formed in said shelf adjacent said tongue for supporting said shelf on the side rail of a ladder; said support means having at least one angled side wall formed thereon.
